(19) United States
(12) Patent Application Publication
(10) Pub. No.: US 2013/0278157 A1
(43) Pub. Date: Oct. 24, 2013

(54) DEVICE AND METHOD FOR CONTROLLING CURRENT TO SOLID STATE LIGHTING CIRCUIT

(71) Applicant: Harald Josef Günther Radermacher, Aachen (DE)

(72) Inventor: Harald Josef Günther Radermacher, Aachen (DE)

(73) Assignee: KONINKLIJKE PHILIPS ELECTRONICS N.V., EINDHOVEN (NL)

(21) Appl. No.: 13/995,981

(22) PCT Filed: Dec. 16, 2011
(86) PCT No.: PCT/IB2011/055747

§ 371 Date: Jun. 20, 2013

Related U.S. Application Data
(60) Provisional application No. 61/425,334, filed on Dec. 21, 2010.

(51) Int. Cl. H05B 33/08

(52) U.S. Cl. CPC H05B 33/0815
USPC 315/186

(57) ABSTRACT

A device for controlling current to a solid state lighting load includes a capacitor (241, 341) and a current source (245, 345). The capacitor is connected in a parallel arrangement with the solid state lighting load (260, 360). The current source is connected in series with the parallel arrangement of the capacitor and the solid state lighting load. The current source is configured to modulate dynamically an amplitude of an input current provided to the parallel arrangement of the capacitor and the solid state lighting load based on an input voltage.

### TECHNICAL FIELD

The present invention is directed generally to control of solid state lighting devices. More particularly, various inventive methods and apparatus disclosed herein relate to controlling power factor and efficiency of solid state lighting device driver.

### BACKGROUND

Digital lighting technologies, i.e. illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g., red, green and blue, as well as a processor for independently controlling the output of the LEDs in order to generate a variety of colors and color-changing lighting effects, for example, as discussed in detail in U.S. Pat. Nos. 6,016,038 and 6,211,626.

Typically, an LED-based lighting unit or LED load that includes multiple LED-based light sources, such as a string of LEDs connected in series, is driven by a power converter, which receives voltage and current from mains power supply. To reduce driver cost, the LED load may be driven directly from the mains power supply, as an alternative, including AC and DC operation. However, there are drawbacks related to AC driving directly from the mains power supply. For example, the current waveform provided to the LED load has a high peak value compared to the average value. Therefore, the LED load is driven with a reduced efficiency due to droop, as well as a low power factor. Also, current flow is only possible when the instantaneous mains voltage is higher than the forward voltage of the LED load. Therefore, there may be relatively long periods during which no current flows to the LED string and no light is produced, causing flicker.

To partially address these issues, a rectifier circuit may be connected between the mains power supply and the lighting unit, and a capacitor may be connected in parallel with the LED load within the lighting unit. For example, FIG. 1 illustrates a circuit diagram of a conventional LED-based lighting unit 100, which includes bridge rectifier circuit 110, LED load 160 and capacitor 141, which acts as a power factor control (PFC) and smoothing circuit 140. The capacitor 141 is connected in parallel with the LED load 160, which includes resistor 163 connected in series with a string of one or more LED light sources, indicated by LEDs 161 and 162. The bridge rectifier circuit 110 is connected to mains power source 101 via resistor 105, and includes diodes 111 to 114. The bridge rectifier circuit 110 thus outputs a rectified mains voltage or input voltage Urect to the circuit 140.

However, due to the charging and discharging waveform of capacitor current I_{C} input to the capacitor 141 and the shape of the mains voltage waveform, the LED-based lighting unit 100 typically consumes current, e.g., to recharge the capacitor 141, within a relatively short time period, resulting in high current peaks and a low power factor. In addition, predominantly the resistor 105 connected to the mains power source 101 limits both the repetitive and the initial charging of the capacitor 141. Therefore, when the LED load 160 is initially turned on, there may be an excessive in-rush current. For example, if the LED load 160 is turned on during a mains voltage peak of the mains power source 101, the capacitor current I_{C} of the capacitor 141 may be relatively large, as compared to nominal operation. As a result, unless LED load 160 includes several light sources connected to one circuit in series, resulting in a relatively low value of the nominal LED operation current, due to the further components in the LED-based lighting unit 100, already a relatively small number of light sources will be enough to trigger a magnetic release of the circuit breaker. Therefore, the number of LED-based lighting units 100 connectable to one circuit may be dramatically lower (e.g. only 1/10 or even 1/50) than one may expect according to the nominal current.

From efficiency point of view, and when looking at an individual LED-based light source, the waveform of the current does not present a problem. However, when locking at a large number of LED-based light sources, high currents during a short time interval create distortion on the mains grid and may trigger a circuit breaker (e.g., trigger a fast acting magnetic release of a circuit breaker). Due to the mains distortion, use of LED loads with very low power factors is prohibited by regulation. For example, in Europe, the required power factor may be as low as 0.5, which is attainable using the rectifier and capacitor solution, described above. However, other regions require relatively high power factors, such as 0.7 or higher, e.g. 0.9.

Thus, there is a need in the art to AC drive LED-based lighting units directly from the mains power supply, while maintaining relatively high power factors. In addition, there is a need in the art for preventing excessive in-rush currents when initially turning on LED-based lighting units driven directly from the mains power supply.

### SUMMARY

The present disclosure is directed to inventive devises and methods for using a dynamically modulated current source in series with a capacitor in an LED lighting unit to shape the capacitor current, thus improving the power factor of the LED lighting unit, while increasing or maximizing efficiency, as well as reducing a peak power dissipation in the current source. Further, the modulated current source limits the input current, preventing the LED lighting unit from triggering a circuit breaker.

Generally, in one aspect, a device is provided for controlling current to a solid state lighting load, the device including a capacitor and a current source. The capacitor is connected in a parallel arrangement with the solid state lighting load. The current source is connected in series with the parallel arrangement of the capacitor and the solid state lighting load, the current source being configured to modulate dynamically an amplitude of an input current provided to the parallel arrangement of the capacitor and the solid state lighting load based on an input voltage.

In another aspect, a device is provided for controlling current to a light emitting diode (LED) load, the device including a capacitor, a transistor and a modulation control circuit. The capacitor is connected in parallel with the LED load. The transistor is connected in series between the capacitor and a bridge rectifier circuit providing a rectified input voltage. The modulation control circuit is connected in parallel with the capacitor and the transistor, and configured to receive the rectified input voltage from the bridge rectifier circuit. The modulation control circuit includes a current mirror connected to a gate of the transistor, the current mirror being selectively activated and deactivated to downward and upward modulate an amplitude of a current through the capacitor based on an input voltage from the bridge rectifier circuit.

In another aspect, a method is provided for controlling current to a solid state lighting load. The method includes receiving an input voltage having a waveform, and adjusting an amplitude modulation of a capacitor current of a capacitor connected in parallel with the solid state lighting load, in response to at least one of the waveform of the received input voltage and a time delay in the waveform of the received input voltage. Adjusting the amplitude modulation of the capacitor current changes at least one of a power factor and operation efficiency of the solid state lighting load.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a circuit diagram of a conventional device for controlling current to an LED circuit.

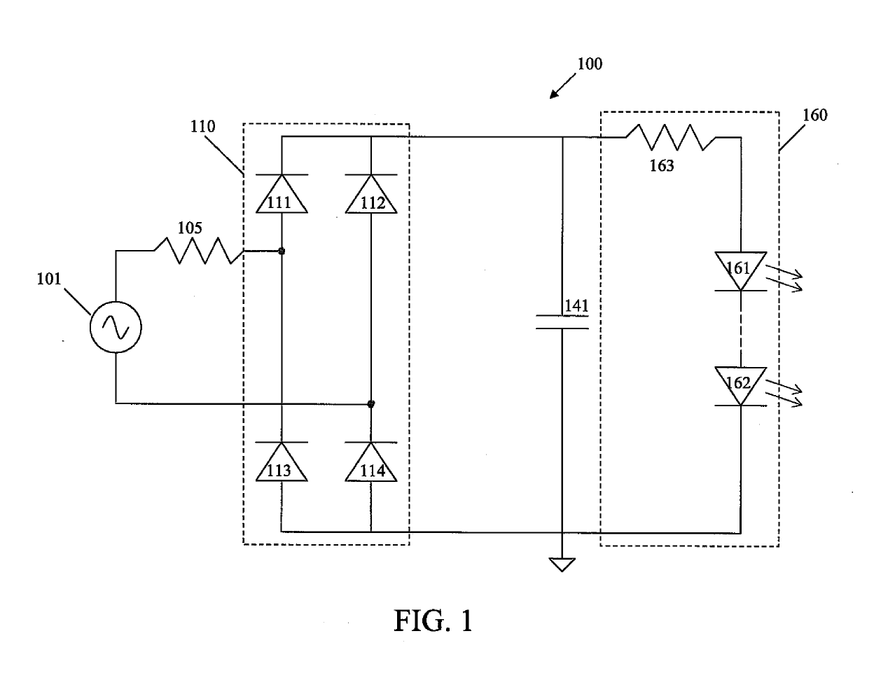

FIG. 2 illustrates a circuit diagram of a device for controlling current to an LED circuit, according to a representative embodiment.

FIG. 3 illustrates a circuit diagram of a device for controlling current to an LED circuit, according to a representative embodiment.

FIG. 4 illustrates a circuit diagram of a device for controlling current to an LED circuit, according to a representative embodiment.

FIG. 5 illustrates traces of input current and LED current waveforms provided by a device for controlling current to an LED circuit, according to a representative embodiment.

FIG. 6 is a graph showing simulated performance of a device for controlling current to an LED circuit, according to a representative embodiment.

### DETAILED DESCRIPTION

More generally, Applicants have recognized and appreciated that it would be beneficial to maintain high power factors and efficiency while driving LED-based lighting units directly from the mains power supply. Applicants have further recognized and appreciated that it would be beneficial to prevent excessive in-rush currents when initially turning on LED-based lighting units driven directly from the mains power supply.

In view of the foregoing, various embodiments and implementations of the present invention are directed to a driver for an LED-based lighting unit that performs active input current shaping. That is, the driver includes a current source configured to modulate dynamically an amplitude of an input current in response to a waveform of the input voltage, although other input criteria may be used. For example, the amplitude of the input current may be modulated in response to time delay or a combination of time delay and waveform of the input voltage, without departing from the scope of the present teachings. Accordingly, the current of a capacitor connected in parallel with the LED-based lighting unit is actively controlled and shaped towards a time-dependent or state-dependent value. By application of a different shaped current waveform (e.g., having different amplitudes), the power factor and electrical efficiency of the LED-based lighting unit is influenced, so that the LED light sources can be “tuned” to a desired power factor, while maintaining high efficiency. Also, peak power dissipation in the current source may be reduced. The driver may be used, for example, in low wattage LED retrofit lamps and modules with higher power factors.

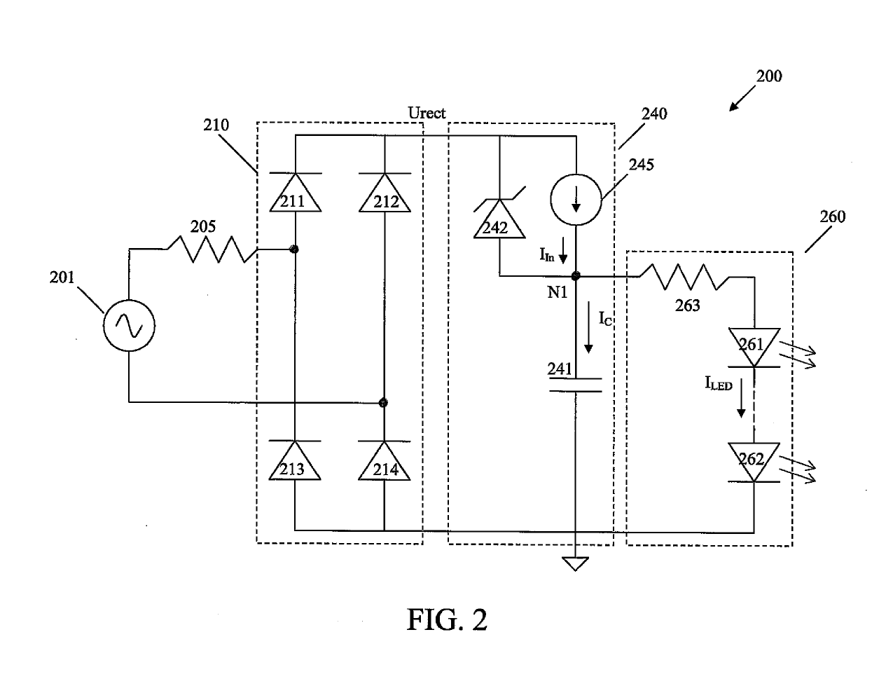

FIG. 2 illustrates a circuit diagram of a device for controlling current to a solid state lighting load, such as an LED circuit, according to a representative embodiment.

Referring to FIG. 2, LED-based lighting unit 200 includes bridge rectifier circuit 210, PFC and smooth circuit 240, and LED load 260. The bridge rectifier circuit 210 is connected to mains power source 201 via resistor 205, and includes diodes 211 to 214. The bridge rectifier circuit 210 thus outputs a rectified mains voltage Urect to the PFC and smoothing circuit 240. Some implementations of the LED-based lighting unit 200 may include additional components, as well, as would be apparent to one of ordinary skill in the art. For example, to comply with certain mains distortion regulations, circuitry against over-voltage may be present, such as fuses, noise filtering capacitors, thermal protection means, communication interfaces, and the like. However, these additional components will not be described in detail for clarity of illustration.

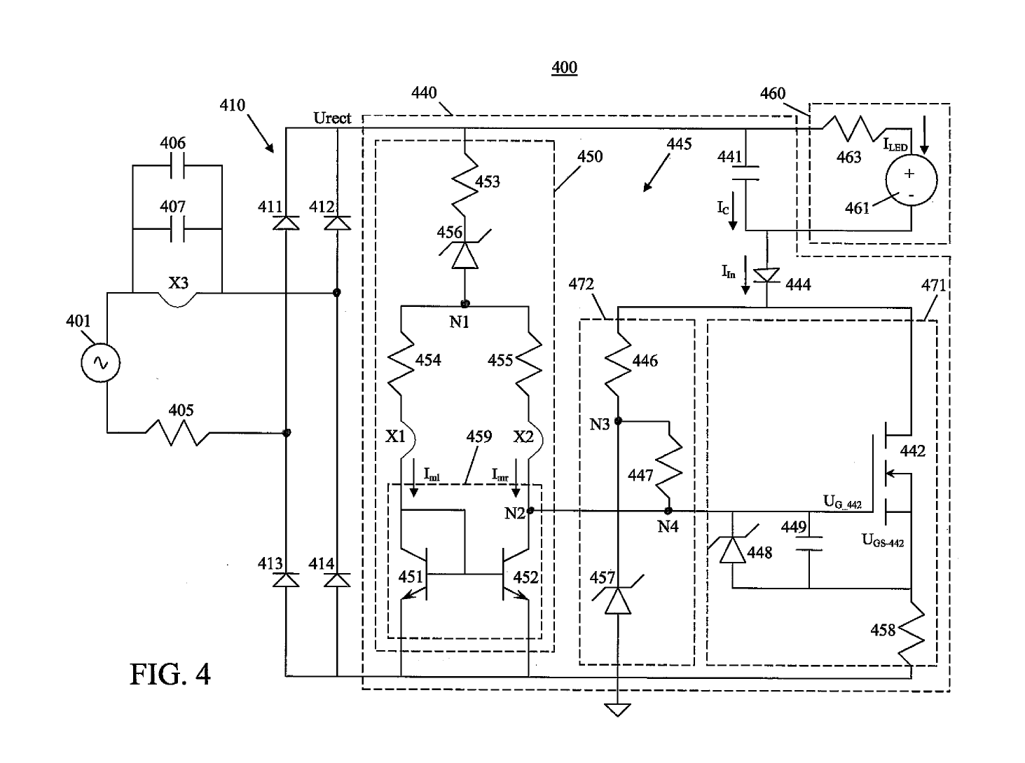

The PFC and smoothing circuit 240 includes current source 245, capacitor 241 and diode 242. The current source 245 is connected in series between a positive output of the bridge rectifier circuit 210 and node N1 to receive rectified input voltage Urect and to output capacitor current I_{C}. The diode 242 is connected in parallel with the current source 245 between the positive output of the bridge rectifier circuit 210 and node N1. The diode 242 may be a Zener diode, for example, and is incorporated for surge protection of the current source 245. For example, without the diode 242, a large voltage spike (e.g., several times higher than the normal rectified mains voltage Urect) would cause a large voltage across the current source 245. As a practical matter, the components of the current source 245 (examples of which are discussed below with reference to FIG. 4) have limited voltage ratings, and thus the diode 242 is selected such that the voltage ratings of these components are not exceeded. In an embodiment, the diode 242 will not carry the surge current, but will overdrive the modulation of the current source 245 to actively clamp the input voltage Urect. In this situation, mainly the resistor 205 provides input current limiting.

The capacitor 241 is connected in series between node N1 and ground, and thus is separated from the output of the rectifier circuit 210 by the current source 245. The capacitor 241 is also connected in parallel with LED load 260, which includes resistor 263 a string of one or more LED light sources, indicated by representative LEDs 261 and 262. The LED load 260 is connected between node N1 and ground, and thus is connected in parallel with the capacitor 241. In the depicted configuration, the resistor 205 and the current source 245 determine the magnitude of the input current I_{In} drawn from the mains power source 201, which provides capacitor current I_{C} (i.e., capacitor charging current and capacitor discharging current) through the capacitor 241 and LED current I_{LED} through the LED load 260, respectively.

The active influence of the current source 245 on the capacitor current I_{C} enables shaping of the capacitor current I_{C}, and hence setting the power factor of the PFC and smoothing circuit 240. The capacitor current I_{C} is not fixed, but varies dynamically over time and/or state. Indeed, some time component may be involved due to the integrating behavior of the capacitor 241. In this example, the capacitor current I_{C} varies in accordance with the waveform of the input voltage Urect from the mains power source 201 and the bridge rectifier circuit 210, although it is understood that the capacitor current I_{C} may alternatively vary in accordance with other and/or additional criteria, such as time delay, as mentioned above. For example, the instantaneous value of the input voltage Urect is measured and used as a control signal for the current source 245. In response to the waveform of the input voltage Urect, the current source 245 modulates the amplitude of the input current I_{In}, resulting in a corresponding modulation in the amplitude of the current given to the parallel arrangement of the capacitor 141 and LED load 260, indicated as the capacitor current I_{C} and the LED current I_{LED}, respectively. In a simple case, the amplitude of the input current I_{In} (starting from a predetermined level) is modulated upward (increased) or modulated downward (decreased) in response to increases and decreases in the instantaneous input voltage Urect, respectively. Assuming a relatively stable value of the LED current I_{LED}, this modulation can be found to a large extent as modulation of the capacitor current I_{C}.

In addition, an in-rush LED current I_{LED} to the LED load 260, i.e., when the LED load 260 is initially connected to the mains power source 201 after having been turned off, is effectively limited. That is, even during start-up, the LED current I_{LED} is limited to the nominal value, completely omitting the inrush effect. This active current limiting function results from the LED load 260 being connected in parallel to the capacitor 241. First, the input current I_{IN} to the parallel arrangement of the capacitor 241 and the LED load 260 is limited, and second, the capacitor 241 acts as a higher frequency component bypass for the LED load 260. Hence, the LED load 260 is effectively protected against inrush current. Also, limiting the input current I_{IN} prevents triggering circuit breakers, as mentioned above.

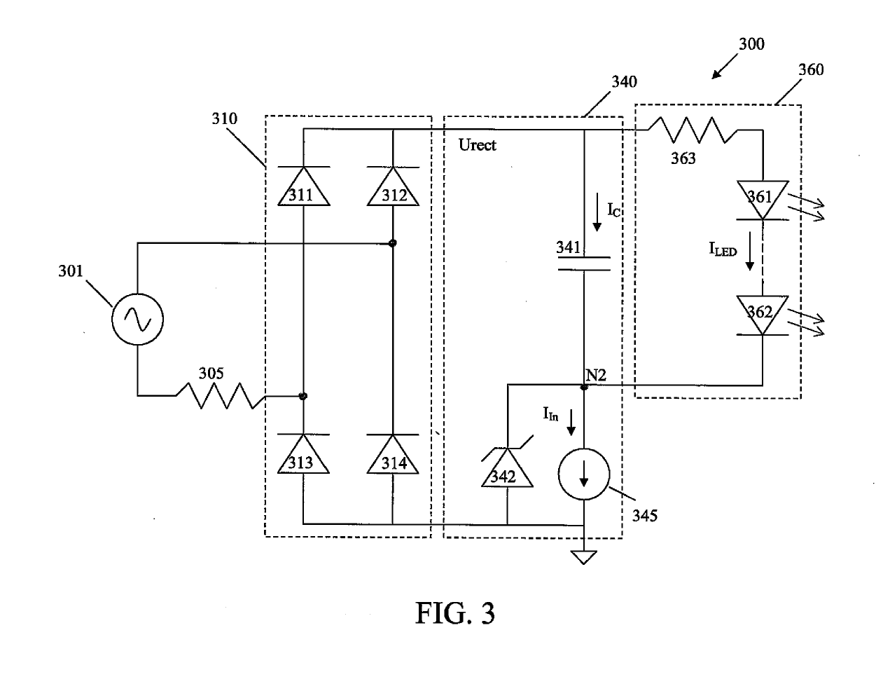

FIG. 3 illustrates a circuit diagram of a device for controlling current to a solid state lighting load, such as an LED circuit, according to a representative embodiment.

Referring to FIG. 3, LED-based lighting unit 300 includes bridge rectifier circuit 310, PFC and smoothing circuit 340 and LED load 360, which are similar to the bridge rectifier circuit 210, the PFC and smoothing circuit 240 and the LED load 260 discussed above with reference to LED-based lighting unit 200. However, the PFC and smoothing circuit 340 in FIG. 3 includes current source 345, capacitor 341 and diode 342, where the current source 345 is connected to the negative output of the bridge rectifier circuit 310. The current source 345 is connected in series between node N2 and ground, and controls modulation of capacitor current I_{C} of the capacitor 341 and LED current I_{LED} in response to the waveform of the input voltage Urect, as discussed above. Otherwise, the configuration and operation of the LED-based lighting unit 300 is substantially the same as discussed above with reference to the LED-based lighting unit 200. The diode 342 is connected in parallel with the current source 345 between the ground output of the bridge rectifier circuit 310 and node N2. As discussed above, the diode 342 may be a Zener diode, for example, and is incorporated for surge protection of the current source 345 and the LED load 360.

FIG. 4 illustrates a circuit diagram of a device for controlling current to a solid state lighting load, such as an LED circuit, according to a representative embodiment. More particularly, FIG. 4 shows an illustrative implementation of a PFC and smoothing circuit, indicated as PFC and smoothing circuit 440, according to a representative embodiment.

Referring to FIG. 4, LED-based lighting unit 400 includes bridge rectifier circuit 410, PFC and smoothing circuit 440 and LED load 460. The bridge rectifier circuit 410 is connected to mains power source 401 via resistor 505, and includes diodes 411 to 414. The bridge rectifier circuit 410 thus outputs a rectified mains voltage Urect to the PFC and smoothing circuit 440. In addition, FIG. 4 incorporates (optional) AC capacitors 406 and 407, to indicate the possibility of altering the input stage. Although two representative capacitors 406 and 407 are depicted, it is understood that one or more capacitors may be present. When no input stage capacitors are used, the input mains current is directly fed to the bridge rectifier 410, as indicated by jumper X3.

The PFC and smoothing circuit 440 includes current source 445 and capacitor 441, where the current source 445 is connected to the negative output of the bridge rectifier circuit 410, as discussed above with reference to the current source 345 shown in FIG. 3. However, it is understood that the current source 445 of FIG. 4 may alternatively be connected to the positive output of the bridge rectifier circuit 410, as discussed above with reference to the current source 245 shown in FIG. 2, without departing from the scope of the present teachings. The capacitor 441 is connected in parallel with the LED load 460, which includes resistor 463 and representative LED load voltage source 461 connected in series.

The current source 445 of the PFC and smoothing circuit 440 includes current source circuit 471 and base level circuit 472. The current source circuit 471 modulates the input current I_{In}, and includes switch or transistor 442 connected in series between the capacitor 441 and ground. The transistor 442 is depicted as a metal oxide semiconductor field effect transistor (MOSFET), although other types of transistors, such as a bipolar junction transistor (BJT), may be incorporated without departing from the scope of the present teachings. The current source circuit 471 also includes resistor 458, diode 448 and capacitor 449, discussed below. The base level circuit 472 determines the nominal, un-modulated input control signal to the current source circuit 471, and includes resistors 446 and 447, and diode 457, which may be a Zener diode, for example.

Generally, the resistor 446 and the diode 457 generate a reference voltage, which is set via the resistor 447 the input control signal of the current source circuit 471. In particular, the input control signal is gated to the transistor 442 and modulation control circuit 450, which includes current mirror 459 that is selectively activated in response to operation of jumper X1. That is, when the jumper X1 is closed and the jumper X2 is opened, the current mirror 459 is activated resulting in downward modulation (lower amplitude) of the input current I_{In}. When the jumper X2 is closed and the jumper X1 is opened, the current mirror 459 is deactivated and a current Iₘᵣ will result in upward modulation (higher amplitude) of the input current I_{Ub}.

More particularly, the modulation control circuit 450 includes resistor 453 and diode 456, which may be a Zener diode, connected in series between the positive output of the bridge rectifier circuit 410 (for receiving input voltage Urect) and node N1. Node N1 is connected to ground through first and second paths. The first path includes resistor 454 selectively connected in series with transistor 451 of the current mirror 459 via first jumper X1. The second path includes resistor 455 selectively connected in series with transistor 452 of the current mirror 459 via first jumper X2. The transistors 451 and 452 are depicted as BJTs for purposes of explanation, but may be any of various types of transistors, including field effect transistors (FETs), for example, without departing form the scope of the present teachings. The transistor 451 has a collector connected to the first jumper X1, an emitter connected to ground, and a base connected to the collector of the transistor 451 and to a base of the transistor 452. The transistor 452 has a collector connected to the second jumper X2, an emitter connected to ground, and a base connected the base and the collector of the transistor 451.

With respect to the transistor 442 of the current source circuit 471, the gate is connected to node N2, which is the collector of the transistor 452. The transistor 442 further includes a drain connected to the capacitor 441 though diode 444, and a source connected to ground through current shunt resistor 458, which provides a current shunt resistance. Capacitor 449 and diode 448, which may be Zener diode, are connected in parallel with one another between the gate and source of the transistor 452. In addition, resistor 446 is connected between diode 444 and node N3. Resistor 447 is connected between nodes N3 and N4, which is the gate of the transistor 442. Diode 457, which may be a Zener diode, is connected between node N3 and ground. Notably, the PFC and smoothing circuit 440 may also include a surge protection diode, such as diode 342 in FIG. 3, which may be connected in parallel with the transistor 442, in parallel with the series connection of the transistor 442 and the resistor 458, in parallel with the resistor 446, or in any other configuration suitable for limiting voltage across the transistor 442. However, for clarity of illustration, the surge protection diode is not shown in FIG. 4.

In the depicted illustrative configuration, the gate voltage of the transistor 442, the gate-source-voltage U_{GS}_{_{—}}₄₄₂ of the transistor 442, and the resistor 458 determine the upper limit of the current through the transistor 442, and thus the upper limit of the input current I_{In} in normal operation, i.e. when over-voltage protections are not active. The gate voltage U_{G}_{_{—}}₄₄₂ of the transistor 442 is normally delivered via the diode 457 and the resistors 446 and 447. Since the gate of the transistor 442 is decoupled to some extent from the voltage of the diode 457 via the resistor 447, it is possible to manipulate the gate voltage U_{G}_{_{—}}₄₄₂ and thus the input current I_{In}. The input current I_{In} is modulated upward or downward a certain amount when the input voltage Urect exceeds a voltage threshold defined by diode 456. Once the voltage threshold has been exceeded, downward modulation is performed via the resistor 454 and the activated current mirror 459 by closing X1, and/or upward modulation is performed via resistor 455 by closing the second jumper X2.

In various embodiments, there may be active control of the functionality, indicated in FIG. 4 by representative jumpers X1 and X2. For example, the jumpers X1 and X2 may be replaced with controllable switches or by other means for activating and deactivating the left and right current paths, respectively, without departing form the scope of the present teachings. The state (e.g., level of the input voltage Urect) at which any of the upward and/or downward modulations is activated may then be selected by additional circuitry (not shown), such as a microprocessor, a processor or a controller.

FIG. 4 depicts a versatile implementation, in which both upward and downward modulations are possible in order to provide maximum flexibility. Of course, alternative implementations enabling only upward or downward modulation may be provided without departing from the scope of the present teachings. For example, a dedicated embodiment, e.g., addressing a certain market with known mains harmonics regulation, may only need to provide upward modulation to achieve the desired combination of efficiency, power factor and mains harmonics. In such a case, there would be no need for the current mirror 459, for example.

In case more flexibility is required, instead of deriving the upward and downward modulation signal from a common voltage signal generated at node N1, one or more zener diodes (not shown) may be added, e.g., in parallel with diode 456, so that the level of the input voltage Urect at which up modulation begins is different from the level of the input voltage Urect at which down modulation begins. As a result, the input control signal for the current source circuit 471 may be the base reference signal from the base level circuit 472, as long as the input voltage Urect is lower than either threshold. The input control signal is modulated upward when the input voltage Urect is higher than a first threshold, but lower than a second threshold, and modulated downward when the input voltage Urect is higher than a second threshold. In this configuration, the first and second threshold levels have to be set accordingly (e.g., by choosing the appropriate diodes), and the “strength” of the modulation signal is determined by the values of the resistors 454, 455 and 447 involved in up and down modulation, which may vary to provide unique benefits for any particular situation or to meet application specific design requirements of various implementations, as would be apparent to one skilled in the art.

In the disclosed embodiments, the current mirror has a ratio of 1:1 between collector current of the transistors 451 and 452. Some energy associated with generating the collector current from the input voltage can be saved when using a current mirror with a different ration, e.g. by using more transistors or other circuitry.

Referring again to FIG. 4, as an example operation of the LED-based lighting unit 400, it may be assumed that the jumper X1 is closed and the jumper X2 is open, enabling downward modulation of the amplitude of the input current I_{In}. In particular, the default programmed current I₀ is indicated by Equation (1), where U₄₅₇ is the voltage across the diode 457, U_{GS}_{_{—}}₄₄₂ is the gate-source-voltage of the transistor 442, and R₄₅₈ is the resistance of the resistor 458:

$${I}_{0} = \frac{{U}_{457} - {U}_{GS \_ 442}}{{R}_{458}} \qquad ( 1 )$$

On the left side of the current mirror 459, current Iₘₗ of the transistor 451 of the current mirror 459 is indicated by Equation (2), where U₄₅₆ is the voltage across the diode 456, U_{BE}_{_{—}}₄₅₂ is the base-emitter voltage of the transistor 452, R₄₅₃ is the resistance of the resistor 453 and R₄₅₄ is the resistance of the resistor 454:

$${I}_{ml} = \frac{Urect - {U}_{456} - {U}_{BE \_ 452}}{{R}_{453} + {R}_{454}} \qquad ( 2 )$$

Typically, the 0.7V of U_{BE}_{_{—}}₄₅₂ may be ignored. Due to the configuration of the current mirror 459, the same value of the current Iₘₗ is provided on the right side of the current mirror 459 as current Iₘᵣ, which is equal to the collector current I_{C}_{_{—}}₄₅₂ at the collector of the transistor 452. The collector current I_{C}_{_{—}}₄₅₂ is drawn through the decoupling resistor 447, resulting in a proportional voltage drop. Therefore, the remaining gate voltage U_{G}_{_{—}}₄₄₂ of the transistor 442 is reduced, and thus the remaining input current I_{In} is limited as shown in Equation (3):

$${I}_{in} = \frac{{U}_{457} - {U}_{GS \_ 442} - {R}_{447} \cdot \frac{( Urect - {U}_{456} )}{{R}_{453} + {R}_{454}}}{{R}_{458}} \qquad ( 3 )$$

Of course, a similar equation may be derived for the upward modulation when jumper X1 is opened and jumper X2 is closed. Also, the values of the various components, the default (maximum) input current In and the degree of downward modulation may vary to provide unique benefits for any particular situation or to meet application specific design requirements of various implementations, as would be apparent to one of ordinary skill in the art. For example, for purposes of illustration, non-limiting values of the various components in FIG. 4 may be as follows: Capacitors 406 and 407 may be 1000 nf and 680 nf, respectively, and the resistor 405 may be 100Ω. In the PFC and smoothing circuit 440, the capacitor 441 may be 5 μf, the capacitor 449 may be 1 nf, the resistor 453 may be 200 kΩ, the resistor 446 may be 39 kΩ, and the resistor 447 may be 22 kΩ. Also, the current mirror transistors 451 and 452 may be NPN BJTs, ad the transistor 442 may be an NMOS MOSFET. In various alternative configurations, the transistors 451 and 452 may PNP BJTs and/or their collectors and emitters may be reversed, and the transistor 442 may a PMOS MOSFET and/or its source and drain may be reversed. In the LED load 460, the resistor may be 470Ω and the LED load voltage source 461 may be a series connection of multiple LED junctions, having a suitable high forward voltage, e.g., around 60 to 130V when operated from a 120V AC grid. The LED load voltage source 461 is included in order to represent the general behavior of an LED load, having a relatively limited input voltage range for operation, e.g., as compared to a resistor. Still, the LED load voltage source 461 will incorporate some resistive behavior. This resistive behavior may be sufficient to realize the functionality depicted by the resistor 463 in FIG. 4, although it may also be that the functionally depicted by the resistor 463 is realized by the internal resistive behavior of the LED load voltage source 461 and an additional resistance (e.g., resistive trace on a circuit board or a resistor).

As stated above, input criteria other than waveform of the input voltage may be used, such as time delay or a combination of time delay and waveform of the input voltage, without departing from the scope of the present teachings. For example, the current source may be actuated according to a waveform, but with a certain time delay. In a representative configuration, the time delay may be realized via a resistor-capacitor delay, e.g., including capacitors 406 and 407 in FIG. 4, or via a real “record and playback” circuit, to capture the waveform of one cycle, shift it in time and use the time shifted signal for modulation in a later part of this cycle or in any subsequent cycle.

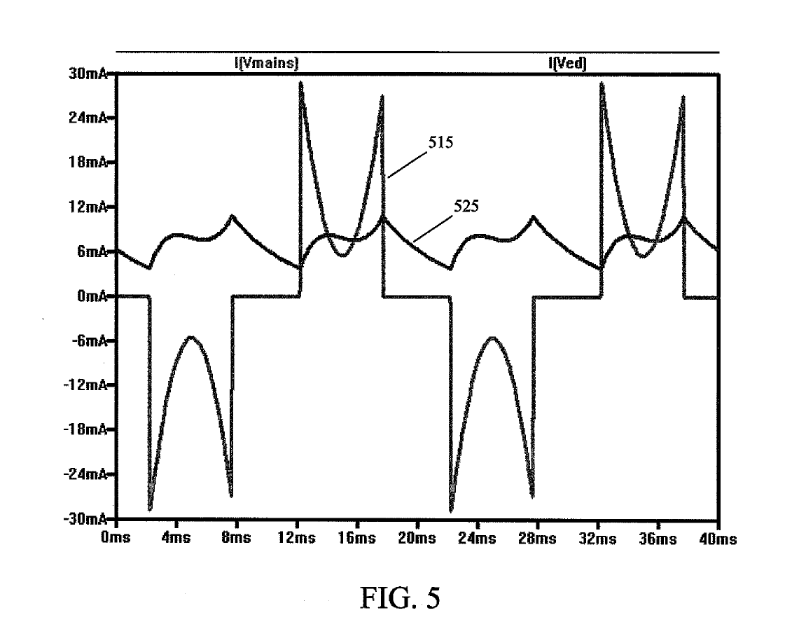

FIG. 5 illustrates traces of input current and LED current waveforms provided by a device for controlling current to an LED circuit, according to a representative embodiment.

Referring to FIG. 5, trace 515 shows a waveform of a representative input current I_{In} and trace 525 shows a resulting waveform of a representative LED current I_{LED}, where the PFC and smoothing circuit 440 provides heavy downward modulation. For example, the trace 525 may result when the jumper X1 is closed and the jumper X2 is open, activating the current mirror 459 of the PFC and smoothing circuit 440. A benefit of downward modulation is that the current is reduced while the voltage difference between the input voltage Urect and the capacitor voltage across the transistor 442 is maximum. This voltage difference is the drop-out voltage across the current source 445, which to a large extent is the voltage across the transistor 4442. By reducing the input current I_{In} at this high level of the input voltage Urect, the energy dissipation in the current source 445 is limited, and thus the efficiency is increased. Of course, a certain average input current I_{In} must be delivered to the LED load 460. The higher input current I_{In} at the lower levels of the input voltage Urect provides more charging current (capacitor current I_{C}) to the capacitor 441, to achieve the desired level of average LED current I_{LED} to the LED load 460. With this downward modulation, efficiency is increased and the peak thermal loading (stress) of the current source 445 is beneficially reduced. In addition, flicker of the LED load 460 is reduced, since the total charging of the capacitor 441 is effectively split into two portions, resulting in a reduced voltage ripple across the capacitor 441 and hence reduced ripple of the LED current I_{LED}. Furthermore, the ripple of the LED current I_{LED} incorporates higher frequency components, where the human eye is less sensitive.

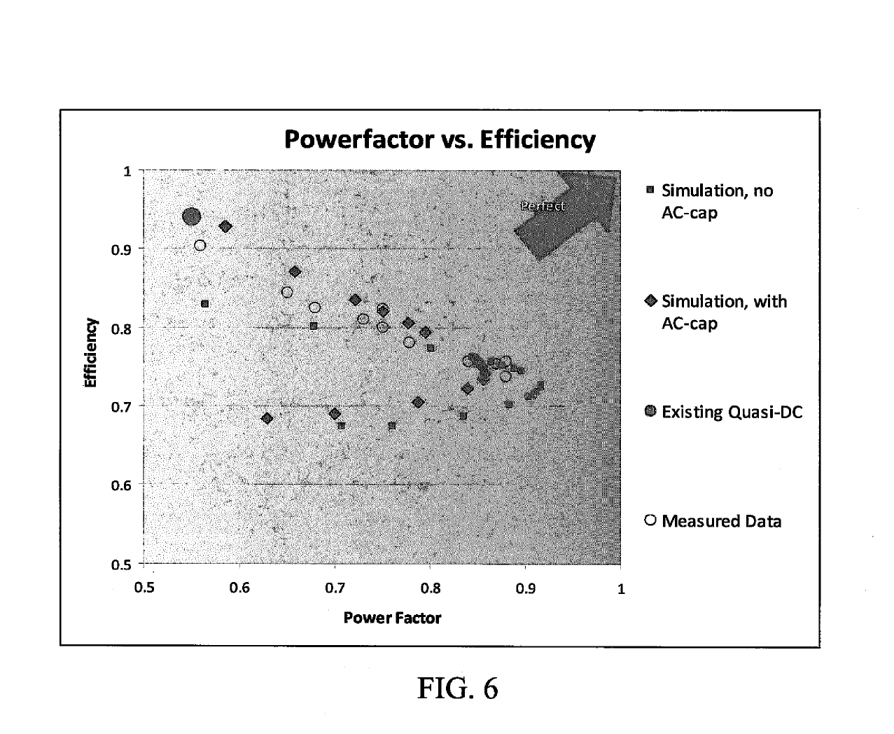

FIG. 6 is a graph showing simulated performance of a device for controlling current to an LED circuit, according to a representative embodiment. In particular, FIG. 6 shows operation points (e.g., including one or more AC side capacitors 460, 407) ranging from an efficiency of about 92 percent for a power factor of about 0.58 to an efficiency of about 75 percent for a power factor of about 0.85, indicated by black diamonds. Additional simulations of performance show operation points (e.g., with no AC side capacitors) ranging from an efficiency of about 83 percent for a power factor of about 0.56 to an efficiency of about 72 percent for a power factor of about 0.91, indicated by black squares. For purposes of comparison, FIG. 6 also shows the existing quasi-DC operation point, indicated by a black circle, and measured data, indicated by open circles.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

Any reference numerals or other characters, appearing between parentheses in the claims, are provided merely for convenience and are not intended to limit the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

1. A device for controlling current to a solid state lighting load, the device comprising:
a capacitor connected in a parallel arrangement with the solid state lighting load; and
a current source connected in series with the parallel arrangement of the capacitor and the solid state lighting load, the current source being configured to modulate dynamically an amplitude of an input current provided to the parallel arrangement of the capacitor and the solid state lighting load based on an input voltage.

2. The device of claim 1, wherein the solid state lighting load comprises at least one light-emitting diode (LED) connected in series.

3. The device of claim 2, wherein the modulated amplitude of the input current maximizes operational efficiency of the solid state lighting load and increases a power factor (PF) of the solid state lighting load to at least a minimum PF requirement.

4. The device of claim 2, wherein the modulated amplitude of the input current reduces peak power dissipation in the current source.

5. The device of claim 1, further comprising:
a diode providing surge protection of the current source, connected in parallel with the current source.

6. The device of claim 5, wherein the diode comprises a Zener diode.

7. The device of claim 1, wherein the current source comprises a metal oxide semiconductor field effect transistor (MOSFET).

8. The device of claim 1, wherein the current source comprises a bipolar junction transistor (BJT).

9. The device of claim 1, wherein the input voltage is provided by a rectifier supplied from an AC source.

10. The device of claim 9, wherein the rectifier is a bridge rectifier and the AC source is a mains voltage source.

11. A device for controlling current to a light emitting diode (LED) load, the device comprising:
a capacitor connected in parallel with the LED load;
a transistor connected in series between the capacitor and a bridge rectifier circuit providing a rectified input voltage; and
a modulation control circuit connected in parallel with the capacitor and the transistor and configured to receive the rectified input voltage from the bridge rectifier circuit, the modulation control circuit comprising a current mirror connected to a gate of the transistor, the current mirror being selectively activated and deactivated to downward and upward modulate an amplitude of a current through the capacitor based on an input voltage from the bridge rectifier circuit.

12. The device of claim 11, wherein the current mirror comprises a plurality of current mirror transistors.

13. The device of claim 12, wherein the modulation control circuit further comprises:
a first resistor and a diode connected in series between the bridge rectifier circuit and a first node;
a first path connected between the first node and ground, the first path comprising a second resistor and the current mirror; and
a second path connected between the first node and ground, the second path comprising a third resistor and one of the current mirror transistors of the current mirror,
wherein selection of the first path causes downward modulation of the current through the capacitor, and selection of the second path causes upward modulation of the current through the capacitor.

14. The device of claim 13, wherein the modulation control circuit further comprises:
a diode connected in series between the first resistor and the first node, wherein the current through the capacitor is modulated upward or downward when the input voltage exceeds a voltage threshold defined by the diode.

15. The device of claim 12, wherein the transistor comprises a MOSFET.

16. The device of claim 15, wherein each of the current mirror transistors comprises a bipolar junction transistor (BJT).

17. The device of claim 15, wherein the modulation control circuit further comprises a current shunt resistor connected in series between the transistor and ground, a gate-source-voltage of the transistor and the current shunt resistor determining an upper limit of a current through the transistor.

18. The device of claim 11, further comprising:
at least one capacitor selectively connectable to the bridge rectifier circuit to alter the input voltage.

19. A method for controlling current to a solid state lighting load, the method comprising:
receiving an input voltage (Urect) having a waveform; and
adjusting an amplitude modulation of a capacitor current of a capacitor connected in parallel with the solid state lighting load, in response to at least one of the waveform of the received input voltage and a time delay in the waveform of the received input voltage, wherein adjusting the amplitude modulation of the capacitor current changes at least one of a power factor and operation efficiency of the solid state lighting load.

20. The method of claim 20, wherein the input voltage comprises a rectified voltage received from a bridge rectifier circuit.
